(19) United States
(12) Patent Application Publication
(10) Pub. No.: US 2020/0387872 A1
(43) Pub. Date: Dec. 10, 2020

(54) JOB DESCRIPTION AND QUESTION APPLICATION MODEL

(71) Applicant: Microsoft Technology Licensing, LLC, Redmond, WA (US)

(72) Inventors: Katherine Ji Zhou, San Francisco, CA (US); Lauri Janet Moore, Portola Valley, CA (US); Rafael E. Crespo, Sunnyvale, CA (US); Luke Rudolf Flesch, San Francisco, CA (US); Ramil Libatique Nobleza, Daly City, CA (US); Steven Nguyen Dao, San Francisco, CA (US)

(21) Appl. No.: 16/435,296

(22) Filed: Jun. 7, 2019

(51) Int. Cl. G06Q 10/10; G06Q 50/00; G06F 17/24; G06F 3/0484

(52) U.S. Cl. CPC G06Q 10/1053; G06F 3/0484; G06F 17/243; G06Q 50/01

(57) ABSTRACT

A machine for facilitating the applying for a job associated with a third party from an online service. The machine causes display of a job identifier in a user interface of a client device. The job is associated with a third party. The machine receives a request from the client device to view a job description for the job. The machine causes display of the job description and one or more questions for the job in the user interface. The machine receives, from the client device, one or more answers to the one or more questions and a request to apply for the job via the user interface. The machine generates, at the online service, an application for the job. The application includes the one or more answers to the one or more questions. The machine provides the third party with access to the application.

### TECHNICAL FIELD

The present application relates generally to systems, methods, and computer program products for facilitating the applying for a job associated with a third party from a web site of an online service.

### BACKGROUND

Generally, when an online service publishes jobs associated with a third party (e.g., a company, an organization, an employer, a hirer, etc.), the online service integrates with a partner Applicant Tracking System (ATS) associated with the third party to either obtain job application data from a site associated with the ATS or to call an Application Programming interface (API) provided by the ATS to retrieve job descriptions. Usually, for every ATS with which the online service integrates, a new script is written and maintained. The scripts can become complicated and difficult to maintain, resulting in the inefficient use of computer and network resources. Inefficient use of computer and network resources make scalability of a job application system technically problematic.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2A illustrates an example user interface for facilitating the applying for a job associated with a third party from a web site of the online service, according to some example embodiments;

FIG. 2B illustrates an example user interface for facilitating the applying for a job associated with a third party from a web site of the online service, according to some example embodiments;

FIG. 2C illustrates an example user interface for facilitating the applying for a job associated with a third party from a web site of the online service, according to some example embodiments;

FIG. 3 is a block diagram illustrating components of an application system, according to some example embodiments;

FIG. 4 is a flowchart illustrating a method for facilitating the applying for a job associated with a third party from a web site of the online service, according to some example embodiments;

FIG. 5 is a flowchart illustrating a method for facilitating the applying for a job associated with a third party from a web site of the online service, and representing additional steps of FIG. 4, according to some example embodiments;

FIG. 6 is a flowchart illustrating a method for facilitating the applying for a job associated with a third party from a web site of the online service, and representing additional steps of FIG. 4, according to some example embodiments;

FIG. 7 is a flowchart illustrating a method for facilitating the applying for a job associated with a third party from a web site of the online service, and representing additional steps of FIG. 4, according to some example embodiments;

FIG. 8 is a flowchart illustrating a method for facilitating the applying for a job associated with a third party from a web site of the online service, and representing additional steps of FIG. 4, according to some example embodiments;

FIG. 9 is a flowchart illustrating a method for facilitating the applying for a job associated with a third party from a web site of the online service, and representing step 406 of FIG. 4 in more detail, according to some example embodiments;

FIG. 10 is a flowchart illustrating a method for facilitating the applying for a job associated with a third party from a web site of the online service, and representing step 406 of FIG. 4 in more detail, according to some example embodiments;

FIG. 11 illustrates an example mobile device, according to various embodiments; and

FIG. 12 is a block diagram illustrating components of a machine, according to some example embodiments, able to read instructions from a machine-readable medium and perform any one or more of the methodologies discussed herein.

### DETAILED DESCRIP HON

### I. Overview

Generally, when an online service (e.g., a social networking service, hereinafter also “SNS”) publishes jobs associated with a third party (e.g., a company, an organization, etc.), the online service integrates with a partner Applicant Tracking System (ATS) associated with the third party to either obtain job application data from a site associated with the ATS or to call an Application Programming Interface (API) provided by the ATS to retrieve job descriptions. Usually, for every ATS with which the online service integrates, a new script is written and maintained. The scripts can become complicated and difficult to maintain. In addition, for some jobs, job application questions are also provided at some of the ATSs and need to be obtained before applicants can apply for those jobs. Inefficient use of computer and network resources make scalability of a job application system technically problematic.

Given a large number of ATSs that may partner with an online service, the technical difficulties of the online service efficiently maintaining a large number of scripts for integrating with the many ATSs and of managing network resources for successful integration with the partner ATSs, a job application system, as disclosed herein, that obtains application questions at the same time it obtains corresponding job descriptions from third parties via ATSs, and facilitates the applying for jobs associated with the third parties from a web site of the online service without redirecting the job application process to web sites associated with the third parties also provides a technical solution to the technical problem of excessive consumption of the electronic resources of a computer system managing the job application process.

In some example embodiments, a job application system (hereinafter also “an application system”) causes display of an identifier of a job in a user interface of a client device associated with a user of an online service. The job is associated with a third party. The application system receives, at a server associated with the online service, a request from the client device. The request is to view a job description for the job. In response to the request to view the job description, the application system causes display of the job description and one or more questions for the job in the user interface of the client device. The application system receives, at the server associated with the online service, from the client device, one or more answers to the one or more questions and a request to apply for the job via the user interface. In response to the request to apply for the job, the application system generates, at the server associated with the online service, an application for the job. The application includes the one or more answers to the one or more questions. The application system provides the third party with access to the application. The application system applies this process to both basic jobs and upgraded jobs (e.g., jobs identified as premium jobs based on urgency to till the position, type of job, etc.

In some example embodiments, the providing the third party with access to the application includes transmitting the application to a server associated with the third party. In some example embodiments, the providing the third party with access to the application includes exposing one or more Application Programming Interfaces (APIs) to the third party. The one or more APIs can be used by the third party to access (e.g., retrieve) various information related to one or more posted jobs or to one or more job applications.

For example, a first API (e.g., a first Representational State Transfer (REST) service) allows a third party client to retrieve a list of jobs that are associated with the contract between the third party and the online service, and that have been posted on the online service (e.g., all the jobs since the beginning of the contract, or the jobs posted on a particular date or within a period of time). The retrieved list of jobs may include job posting identifiers that identify the jobs posted on the online service on behalf of the third party.

A second REST service may allow the third party client to retrieve a list of job applications associated with a given job posting. The list of job applications may include job application identifiers associated with the applications generated, by the application system, for the given job posting.

A third REST service may allow the third party client to retrieve a list of answers associated with a given job application. The list of answers may also include the questions' text and, if applicable, the normalized question identifiers for the answered questions. The list of answers may also include one or more media identifiers to identify document answers (e.g., a resume) provided by an applicant for the job.

A fourth REST service may allow the third party client to retrieve a document associated with a given media identifier.

Such an application system improves upon existing systems that access job descriptions from various ATSs at a particular time, and then, at a later time, access questions associated with the job descriptions from the various ATSs. The application system improves on the existing systems by eliminating a lag between the time when a job description was ingested from an ATS and the time the questions associated with the job description were added to the job description at the online service based on adding question set fields to the job ingestion pipeline. This allows the third party providing the job description to add the question sets they would like to add to their jobs into xml feeds or html of the jobs that the application system obtains. They are also able to add questions to their jobs through job field processors. As a result, the applicant system does not perform unnecessary operations, such as additional network calls for fetching of question data at a time after the job description data was accessed.

Additionally, the application system improves on the existing systems that redirect the application process to a third-party web site for completion of an application by generating a job application for a user on-site at the online service using the answers provided via the user interface of the client device. This allows for a faster application process. Faster application times increase the efficiency of a computer system that manages a job application process.

Further, the application system improves on the existing systems by pre-filling answers into input elements associated with various job questions in a user interface of a client device during a job application process. This minimizes times associated with answering questions, and leads to higher application completion rate and improved efficiency in the user of computer resources.

Yet another technical improvement provided by the application system is the increase in the efficiency of use of computer resources by providing metrics associated with various aspects of the application process to the third parties that provide the job descriptions and the associated questions. The application system stores various data associated with its users engaging in job application processes (e.g., types of jobs users are interested in, questions answered or not answered by users, types of questions that cause users to abandon an application flow, completed applications, times to completion, users trying to apply again after abandoning a prior application flow, etc.) Using machine learning algorithms and user data pertaining to answering a plurality of job-related questions, the application system generates metrics that measure a likelihood value of completion of applications when certain questions are presented to users, times of completion of applications when certain questions are presented to users, etc. The application system can also indicate questions that lead to users abandoning an application flow. Based on this application-related data provided by the application system to the third parties, the third parties may refine the question sets provided in association with the job descriptions. This leads to fewer interruptions in the application process. As a result, application processing times are shortened, fewer data records are created, and, accordingly, the use of computer and network resources is more efficient.

### II. Detailed Example Embodiments

Example methods and systems for facilitating the applying for a job associated with a third party from a web site of an online service are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

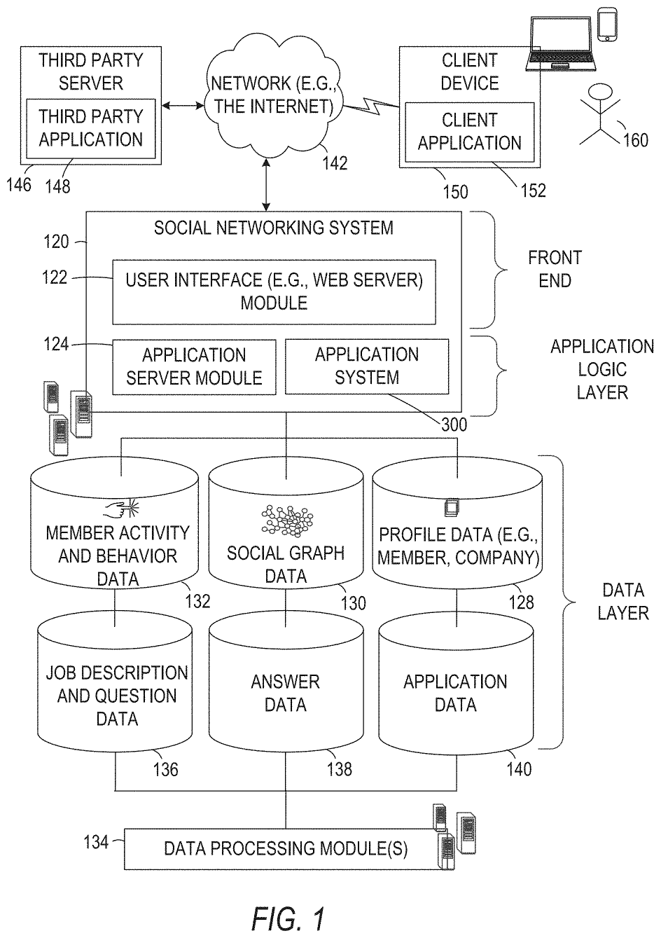

An example method and system for facilitating the applying for a job associated with a third party from a web site of an online service may be implemented in the context of the client-server system illustrated in FIG. 1. As illustrated in FIG. 1, the application system 300 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front-end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 142 to exchange information with the social networking system 120. Each of the client devices 150 may comprise a computing device that includes at least a display and communication capabilities with the network 142 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online content consumption event associated with the member (e.g., an online content item viewed by the member), the date and time when the online content consumption event took place, an identifier of the creative associated with the online content consumption event, a source identifier of the creative associated with the online content item, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the SNS may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122 generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, the social networking system 120 may include the application system 300, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140 process (e.g., execute batch process jobs to analyze or mine) profile data, social graph data, member activity and behavior data, job description and job question data, answer data associated with various job descriptions and job questions, or job application data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party. In some example embodiments, the application system 300 access and transmits job-related data (e.g., job descriptions and questions, metrics, or job applications).

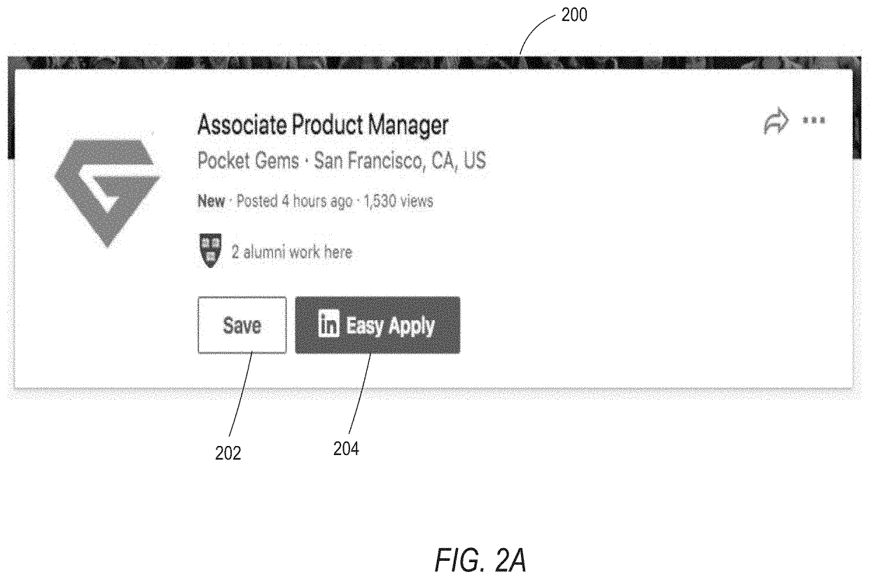

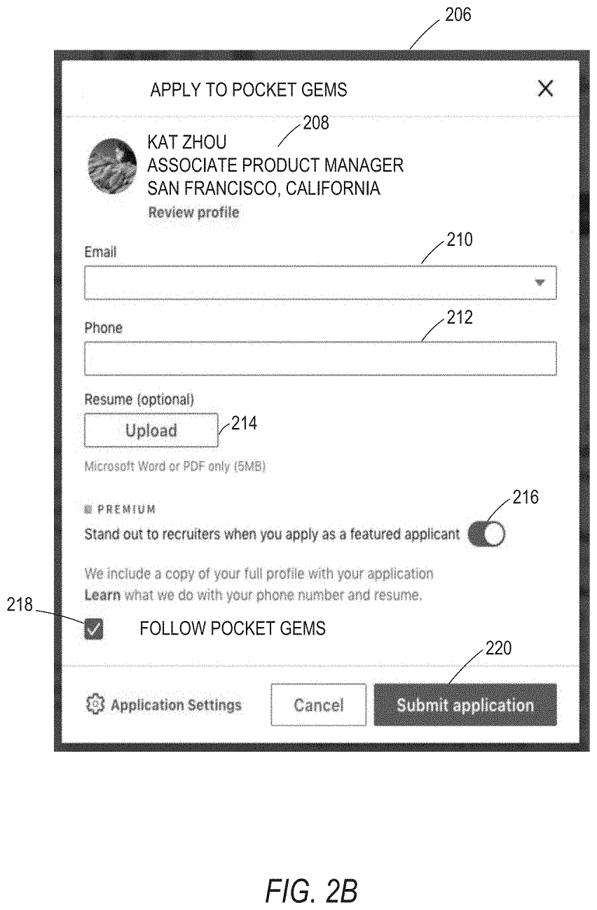

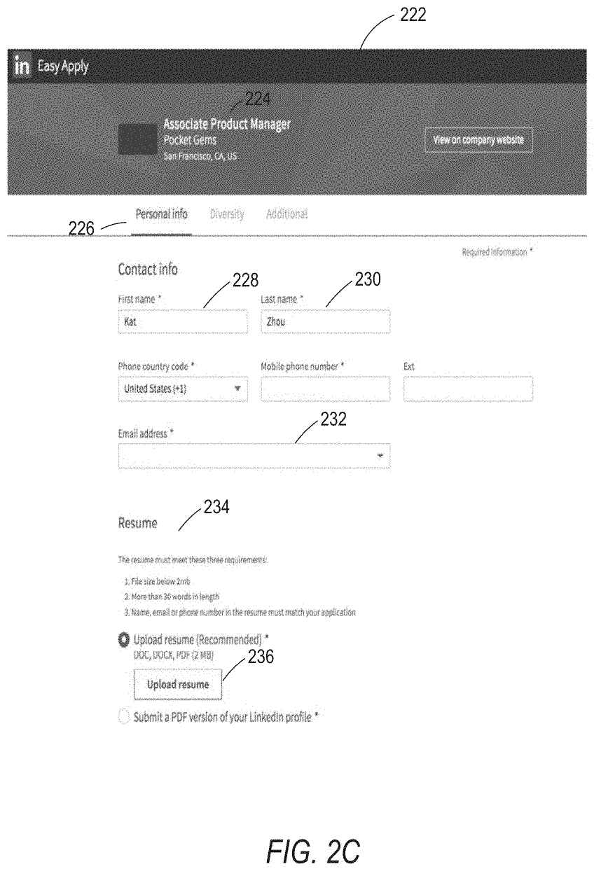

FIG. 2A illustrates an example user interface for facilitating the applying for a job associated with a third party from a web site of the online service, according to some example embodiments. User interface 200 shown in FIG. 2A displays an identifier of a job that includes a title (e.g., Associate Product Manager), the name of the company that posted the job (e.g., Pocket Gems), and a location of the job (e.g., San Francisco, Calif., United States). The user interface 200 also provides additional information pertaining to the posted job, such an indicator of the time when the job was posted (e.g., “4 hours ago”), and an indicator of the number of times the job description has been viewed by users of the online service (e.g., “1,530 views”).

The user interface 200 may be displayed on a client device of a user of the online service. For instance, the user interface 200 may be displayed in a teed of the SNS. The feed may be generated for a particular user, and may be displayed to the particular user after the user logs into the SNS.

The user interface 200 may also include one or more user interface elements, such as a save button 202 and an easy apply button 204. The user may select the save button 202 to request that the application system 300 save the job description. The application system 300 may give the user the option to save the job description on the client device associated with the user, or on the SNS. Another user interface element may provide the user with the option to view more details pertaining to the job (e.g., a detailed description of requirements associated with the posted job).

The user may select the easy apply button 204 to apply for the job via the user interface 200 without leaving the online service (e.g., the SNS). The application process is described in more detail in FIGS. 2B and 2C below.

FIG. 2B illustrates an example user interface for facilitating the applying for a job associated with a third party from a web site of the online service, according to some example embodiments. In some example embodiments, in response to the user selecting the easy apply button 204 of FIG. 2A, the application system 300 causes display of user interface 206 on the client device associated with the user.

As shown in FIG. 2B, the application system 300 populates the user interface 206 with the name of the user, the title of the user, and the location of the user in user interface area 208. Also, the user interface area 208 provides the user with an option to review the user's profile.

The user interface 206 also displays one or more questions associated with the posted job (e.g., “What is your email address?”, “What is your phone number?”, etc.). In some instances, as shown in FIG. 2B, a simplified version of the question (e.g., “email” or “phone”) is displayed in the user interface 206.

Further, the user interface 206 displays one or more input elements of the user interface 206 that correspond to the one or more questions associated with the posted job. For example, input element 210 corresponds to the “email” question, and input element 212 corresponds to the “phone” question.

In some example embodiments, the application system 300 accesses user data associated with the user (e.g., profile data available for the user), and automatically pre-fills the one or more input elements of the user interface 206 with the user data that matches the one or more questions. For example, the application system 300 matches the question “email” with an email addresses associated with the user in a database record that stores profile data of the user on a server of the online service. The application system 300 automatically pre-fills the matching data into the input element 210. If the application system 300 identifies a plurality of email addresses associated with the user in the database record, the application system 300 automatically pre-fills one of the plurality of email addresses in the input element 210, and causes display of a drop-down button in association with the input element 210 to provide the user with the option to change the pre-filled email address with another matched email address associated with the user. In some instances, the application system 300 pre-fills the input element 210 with data previously entered by the user when answering questions for a different employer.

As shown in FIG. 2B, the application system 300 includes an upload button 214 to facilitate the uploading of a resume by the user of the user interface 206. In some example embodiments, the application system 300 generates a resume for the applicant from the applicant's user profile based on a request by the applicant, automatically pre-fills as much information in the generated resume as possible based on the user profile, and causes display of the resume to the applicant for approval via the user interface. The applicant may approve, correct, or supplement the automatically generated resume.

The application system 300 also allows the user to subscribe to a premium service level of the online service via the user of the user interface 206 using the toggle input element 216. Further, the user interface 206 displays the follow input element 218 that can be selected by the user to request a following of the company that posted the job description (e.g., “Pocket Gems”). After the user provided answers to the questions associated with the particular job identifier, the user may select a submit application element 220 of the user interface 206 to request that an application for the job be transmitted to the company on behalf of the user. Based on the provided answers and the request to apply for the job, the application system 300 generates an application for the job on behalf of the user, and transmits the application to a server associated with a third party that provided the job posting (e.g., the company, a recruiter associated with the company, an organization that provides recruiting services to the company, etc.)

FIG. 2C illustrates an example user interface for facilitating the applying for a job associated with a third party from a web site of the online service, according to some example embodiments. As shown in FIG. 2C, an identifier (e.g., a title) of the job, an identifier of the company associated with the job posting, and the location of the job are caused to display in user interface area 224 of the user interface 222. The user interface area 224 also provides the user with an option to view the job description on the company's website.

The selection of the personal information tab 226 in the user interface causes the display of one or more questions associated with the posted job and associated input elements corresponding to various questions. For example, input element 224 corresponds to the shorted version of the question “What is your first name?” (e.g., “First name”). Input element 226 corresponds to the shorted version of the question “What is your last name? (e.g., “Last name”). Input element 228 corresponds to the shorted version of the question “What is your email address?” (e.g., “Email address”). The input elements may be automatically pre-filled with user profile data that matches corresponding questions. The user may change, modify, or update the pre-filled data.

The user interface 222 also includes a resume area 234 that provides requirements pertaining to the resume, an upload resume button 236, and an option to submit the resume in PDF format.

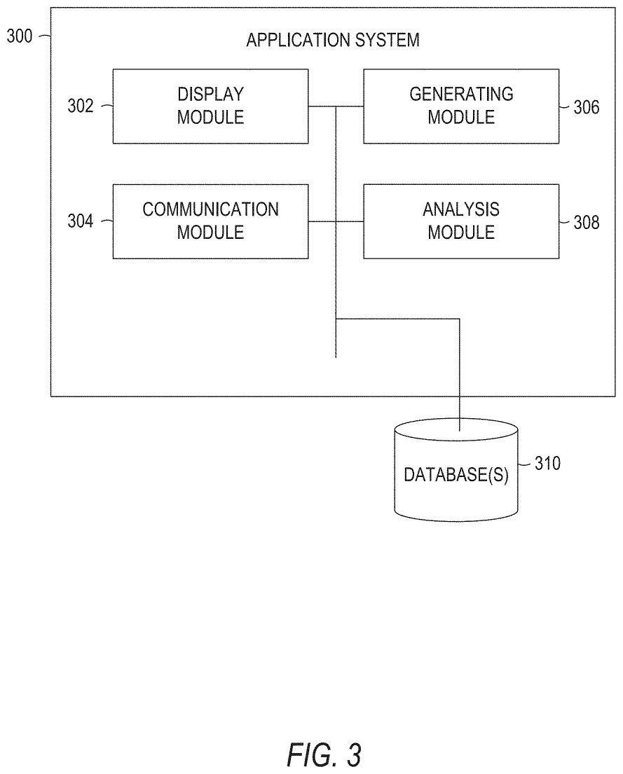

FIG. 3 is a block diagram illustrating components of the application system 300, according to some example embodiments. As shown in FIG. 3, the application system 300 includes a display module 302, a communication module 304, a generating module 306, and an analysis module 308, all configured to communicate with each other (e.g., via a bus, shared memory, or a switch).

According to some example embodiments, the display module 302 causes display of an identifier of a job in a user interface of a client device associated with a user of an online service. The job is associated with a third party. In some example embodiments, the user of the online service is a member of an online social networking system (SNS), such as LinkedIn®.

The job may be advertised via a job posting published on the online service on behalf of the third party. The third party may be an organization different from the online service (e.g., a company, an educational institution, a government organization, a non-governmental organization, a charity organization, etc.). The identifier of the job may be a title associated with the position that the job posting seeks to fill. In some instances, the identifier of the job also includes the name of the third party. For example, a job posting may include a description for a Software Engineer job at Apple Inc. The identifier of the job may be “Software Engineer, Apple Inc.”

The communication module 304 receives, at a server associated with the online service, a request from the client device. The request is to view a job description for the job.

The display module 302 also causes display of the job description and one or more questions for the job in the user interface of the client device. The causing of display is performed in response to the request to view the job description.

In various example embodiments, the communication module 304 accesses (e.g., receives, obtains, retrieves, etc.) the one or more questions for the job from a server associated with the third party. In some example embodiments, the communication module 304 accesses the one or more questions for the job from a server associated with the online service.

The communication module 304 also receives, at the server associated with the online service, from the client device, one or more answers to the one or more questions and a request to apply for the job via the user interface.

The generating module 306 generates, at the server associated with the online service, an application for the job. The application includes the one or more answers to the one or more questions. The generating of the application is performed in response to the request to apply for the job.

The communication module 304 also provides the third party with access to the application.

In some example, the providing the third party with access to the application includes transmitting the application to a server associated with the third party. In various example embodiments, the providing the third party with access to the application includes exposing one or more Application Programming Interfaces (APIs) to the third party. The one or more APIs can be used by the third party to access (e.g., retrieve) various information related to one or more posted jobs or to one or more job applications.

For example, a first API (e.g., a first Representational State Transfer (REST) service) allows a third party client to retrieve a list of jobs that are associated with the contract between the third party and the online service, and that have been posted on the online service (e.g., all the jobs since the beginning of the contract, or the jobs posted on a particular date or within a period of time). The retrieved list of jobs may include job posting identifiers that identify the jobs posted on the online service on behalf of the third party.

A second REST service may allow the third party client to retrieve a list of job applications associated with a given job posting. The list of job applications may include job application identifiers associated with the applications generated, by the application system, for the given job posting.

A third REST service may allow the third party client to retrieve a list of answers associated with a given job application. The list of answers may also include the questions' text and, if applicable, the normalized question identifiers for the answered questions. The list of answers may also include one or more media. identifiers to identify document answers (e.g., a resume) provided by an applicant for the job.

A fourth REST service may allow the third party client to retrieve a document associated with a given media identifier.

The analysis module 308 matches, at the server associated with the online service, a question accessed (e.g., received) from a server associated with a third party, to a normalized question stored in a database record that stores a taxonomy of questions at a server associated with the online service. The analysis module 308 also associates the normalized question with the job description in a database record associated with the identifier of the job at the server associated with the online service.

To perform one or more of its functionalities, the application system 300 may communicate with one or more other systems. For example, an integration system may integrate the application system 300 with one or more email servers, web servers, one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 306 (e.g., database 128, 130, 132, 136, 138, or 140).

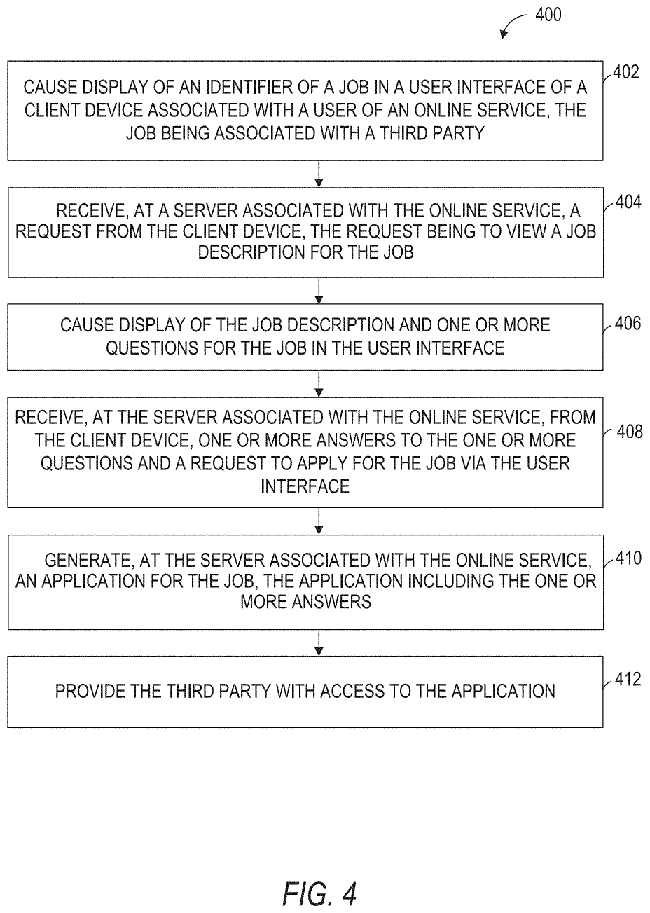

FIGS. 4-10 are flowcharts illustrating a method for facilitating the applying for a job associated with a third party from a web site of a social networking service, according to some example embodiments. Operations in the method 400 illustrated in FIG. 4 may be performed using modules described above with respect to FIG. 3. As shown in FIG. 4, method 400 may include one or more of method operations 402, 404, 406, 408, 410, and 412, according to some example embodiments.

At operation 402, the display module 302 causes display of an identifier of a job in a user interface of a client device associated with a user of the online service. The job is associated with a third party. The third party may be an organization different from the online service (e.g., a company, an educational institution, a government organization, a non-governmental organization, a charity organization, etc.).

At operation 404, the communication module 304 receives, at a server associated with the online service, a request from the client device. The request is to view a job description for the job.

At operation 406, the display module 302 causes display of the job description and one or more questions for the job in the user interface of the client device. The causing of display is performed in response to the request to view the job description.

In various example embodiments, the communication module 304 accesses (e.g., receives, obtains, retrieves, ingests, etc.) the one or more questions for the job from a server associated with the third party. In some example embodiments, the communication module 304 accesses the one or more questions for the job from a server associated with the online service.

At operation 408, the communication module 304 receives, at the server associated with the online service, from the client device, one or more answers to the one or more questions and a request to apply for the job via the user interface.

At operation 410, the generating module 306 generates, at the server associated with the online service, an application for the job. The application includes the one or more answers to the one or more questions. The generating of the application is performed in response to the request to apply for the job.

At operation 412, the communication module 304 provides the third party with access to the application. In some example embodiments, the providing the third party with access to the application includes transmitting the application to a server associated with the third party. In various example embodiments, the providing the third party with access to the application includes exposing one or more Application Programming Interfaces (APIs) to the third party. The one or more APIs can be used by the third party to access (e.g., retrieve) various information related to one or more posted jobs or to one or more job applications.

In some example embodiments, after obtaining the job description, the application system 300 temporarily places a job description into an internal search index, which lists the job but prevents it from being searchable on the online service so that the job identifier does not appear prematurely without questions. Then, the application system 300 calls a location where the question set associated with the job description is stored to associate the question set with the job description. Then, the application system 300 removes the job description and the question set from the internal search index and displays the job description and the question set live in users' feeds.

In some example embodiments, the questions associated with the job identifier are common questions that are asked by many third parties. In some instances, a third party provides a custom question (e.g., a unique question, a novel question, a question that is not commonly asked, etc. with a job identifier. The application system 300 may determine (1) whether it is legal to ask this question, (2) whether the custom question is close enough (e.g., similar) to a normalized question that is already in a database record of the application system 300, (3) whether the third party will accept the normalized question instead of the custom question (e.g., instead of “where did you go to school?” the application system 300 may suggest that the question states “where did you attend university?”), and (3) if it is a truly novel question, the application system 300 may add the custom to its taxonomy of questions. The application system 300 may associate the custom question with the job identifier, and may present the custom question to user viewing the job description associated with the job identifier.

In some example embodiments, to determine whether a custom question complies with legal requirements, the application system 300 may perform a keyword check, a rule check, use machine learning models, or a human review. The legal compliance verification may be performed in near real time.

In some example embodiments, the generating module 306 generates, at the server associated with the online service, a database record that stores at least one of the identifier of the job, an identifier of the user, the one or more questions, the answers to the one or more questions, the application, or a time of the request, by the user, to apply for the job.

In certain example embodiments, the generating module 306 generates, at the server associated with the online service, a database record that stores at least one of the identifier of the job, the job description, or the one or more questions.

In some example embodiments, the analysis module 308 determines that the job is eligible for application via the user interface. The determining may be based on indicator that indicates that the job is eligible for application via the user interface. The indicator may be accessed at (e.g., received from) the server associated with the third party. In some instances, the indicator is included in job data obtained from the server associated with the third party. In some instances, the indicator is stored in a database record on the server associated with the third party. The causing display of the identifier of the job in the user interface of the client device is further based on the determining that the job is eligible for application via the user interface.

In some example embodiments, the analysis module 308 determines that the one or more questions are identified as available to be posted with the job. The causing display of the identifier of the job in the user interface of the client device is further based on the determining that the one or more questions are identified as available to be posted with the job.

In some example embodiments, the communication module 304 provides a set of normalized questions to the third party. The communication module 304 receives an indication of a selection of the one or more questions from the set of normalized questions. The causing display of the identifier of the job in the user interface of the client device is further based on the receiving of the indication.

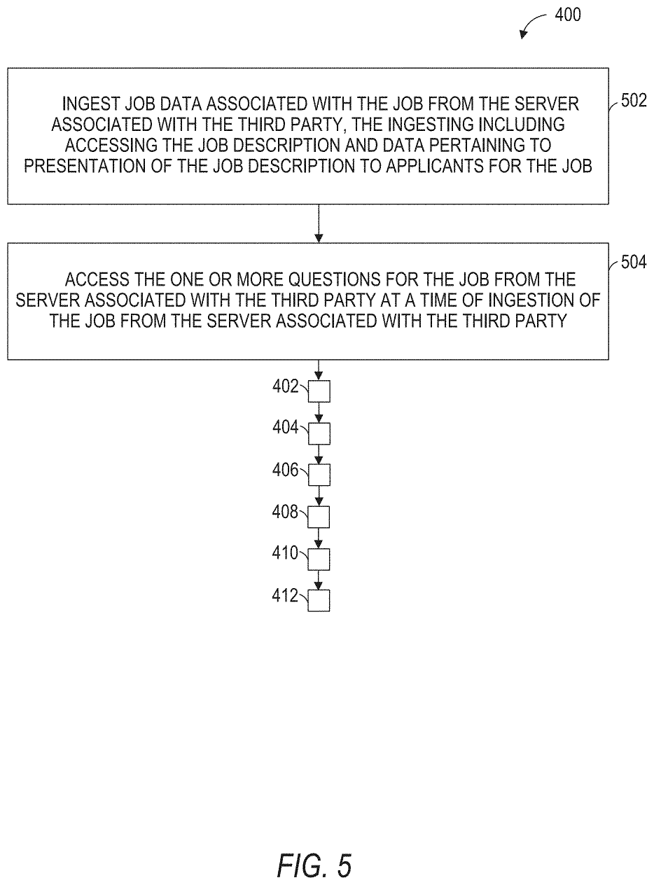

Further details with respect to the method operations of the method 400 are described below with respect to FIGS. 5-10.

As shown in FIG. 5, the method 400 includes one or more of operations 502 or 504, according to some example embodiments. Operation 502 may be performed before operation 402 of FIG. 4, in which the display module 302 causes display of an identifier of a job in a user interface of a client device associated with a user of the online service.

At operation 502, the communication module 304 ingests job data associated with the job from the server associated with the third party. The ingesting includes accessing the job description and data pertaining to presentation of the job description to applicants for the job. In some example embodiments, data pertaining to presentation of the job description to applicants for the job includes some brand elements that would change the look and feel of the application experience. For example, the applicants for a certain job should be presented with access to an active community of users associated with the company that posts the job description (e.g., applicants for a software engineer position at company XYZ should be given access to a group of active users (e.g., employees) associated with the company XYZ). The activation of the “active community” option for the applicants to the particular job may be accomplished by turning on a setting, such as “add active community,” in the job data ingested from the server associated with the third party.

Other examples of brand elements are a particular color, text font, image, video, sound, etc. associated with a brand of the third party. For example, the job data accessed from the server associated with the third party may include a field that includes a hexadecimal code to represent the particular color to be used in the customization of the job presentation to the job applicants.

These brand elements may be used when presenting the job description and the associated questions to a job applicant via the user interface of the client device associated with the job applicant.

At operation 504, the communication module 304 accesses the one or more questions for the job from the server associated with the third party at the time of ingestion of the job from the server associated with the third party.

In some example embodiment, the application system 300 accesses the questions for the job by obtaining job questions using a script (e.g., a GaaP script). The application system 300 may use a script to discover job questions, and, if successful, return a list of job questions that are obtained from an external ATS or the HTML of an external job page, or report back an error (e.g., if the job has been closed).

Also, the application system 300 may use a script to submit applications to the third party. In some instances, the application system 300 submits applications by programmatically filling out a HTML form on the external site, or by providing the applications via an API to which a partner ATS has exposed the application system 300.

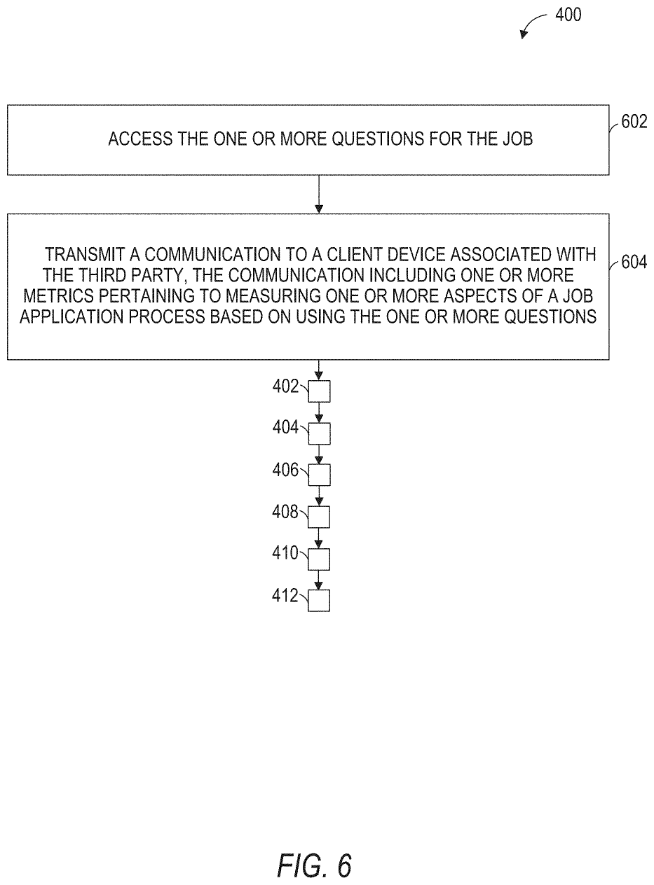

As shown in FIG. 6, the method 400 includes one or more of operations 602 or 604, according to some example embodiments. Operation 602 may be performed before operation 402. of FIG. 4, in which the display module 302 causes display of the identifier of the job in the user interface of the client device associated with the user of the online service.

At operation 602, the communication module 304 accesses the one or more questions for the job. In some example embodiments, the communication module 304 obtains the one or more questions from the server associated with the third party.

At operation 604, the communication module 304 transmits a communication to a client device associated with the third party. The communication includes one or more metrics pertaining to measuring one or more aspects of a job application process based on using the one or more questions. For example, the one or more metrics include a value that indicates the likelihood of providing answers to the one or more questions, a likely time to complete the one or more questions, or a value that indicates the likelihood of a request, by a user, to apply for the job after completing the one or more questions. These metrics may be generated using machine learning algorithms and data pertaining to a plurality of users of the online service who have previously engaged in job application processes on the online service.

For example, the application system 300 communicates to the third party that if the job description is associated with forty questions, it will probably take applicants twenty minutes to complete the questions, at an application completion rate of 83%. The application system 300 may inform the third party that if some of the forty questions are removed, then the completion rate could go up to 95% and the completion time could go down to ten minutes which is a more typical completion time. In some example embodiments, the application system 300 makes suggestions to the third parties based on market insights (e.g., “For similar jobs, these are the questions that were asked, and asking these questions has led to a confirmed hired applicant.” The provided metrics, suggestions, or both, may have an improvement on the metrics associated with the particular job posting.

In various example embodiments, the one or more metrics include a likelihood of completion, by one or more users of the online service including the user, of an application process based on presenting the one or more questions to the one or more users. In some example embodiments, the one or more metrics include a time of completion, by one or more users of the online service including the user, of an application process based on presenting the one or more questions to the one or more users.

In some example embodiments, the one or more metrics are generated using one or more machine learning algorithms and data pertaining to one or more users of the online service. The data pertaining to one or more users of the online service may include activity and behavior data of the one or more users presented with various job application questions, user profile data (e.g., member profile data of members of the SNS), etc.

For example, the online service adds a “confirmed hire” feature to user profile data based on determining that the user updated their online profile to indicate that the user has a new job. The application system 300 may identify what actions the user engaged in during the application process that led to a successful application, and a confirmed hire (e.g., the user confirmed getting the job, the user applied for the third party job on-site at the online service, the set of questions answered by the user, the time to complete each question, the time to complete the application, etc.). The application system 300 may feed this information into a machine learning system to generate metrics that may be presented to third parties during the generation of questions process.

In some example embodiments, the communication module 304 receives approval to present the one or more questions to the user of the online service. The receiving of the approval is in response to the communication that includes the one or more metrics pertaining to measuring the one or more aspects of the job application process based on using the one or more questions.

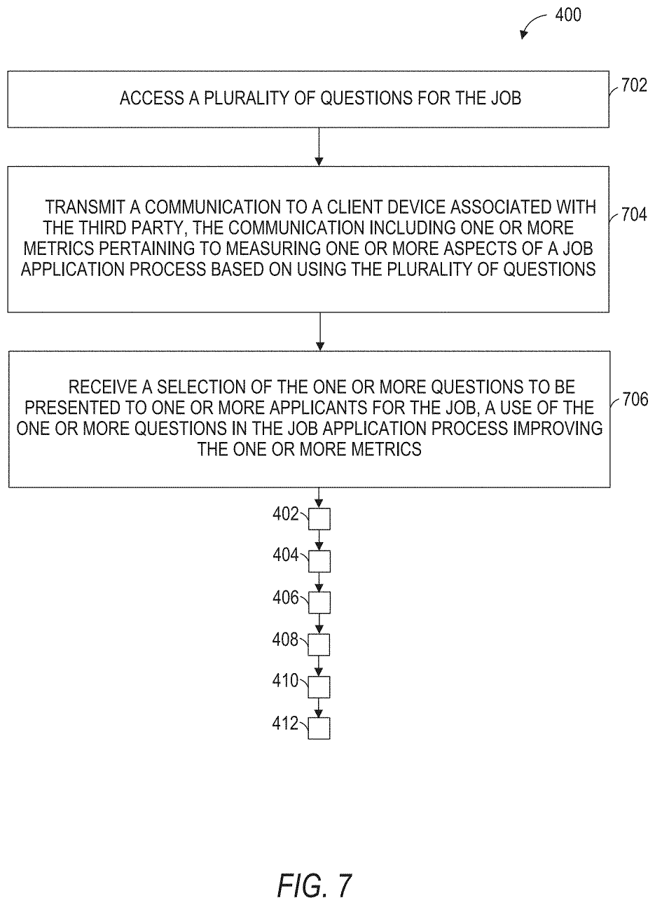

As shown in FIG. 7, the method 400 includes one or more of operations 702, 704, or 706, according to some example embodiments. Operation 702 may be performed before operation 402 of FIG. 4, in which the display module 302 causes display of the identifier of the job in the user interface of the client device associated with the user of the online service.

At operation 702, the communication module 304 accesses a plurality of questions for the job including the one or more questions.

At operation 704, the communication module 304 transmits a communication to a client device associated with the third party. The communication includes one or more metrics pertaining to measuring one or aspects of a job application process based on using the plurality of questions.

At operation 706, the communication module 304, in response to the communication that includes the one or more metrics, receives a selection of the one or more questions to be presented to one or more applicants for the job, wherein the use of the one or more questions in the job application process improves the one or more metrics.

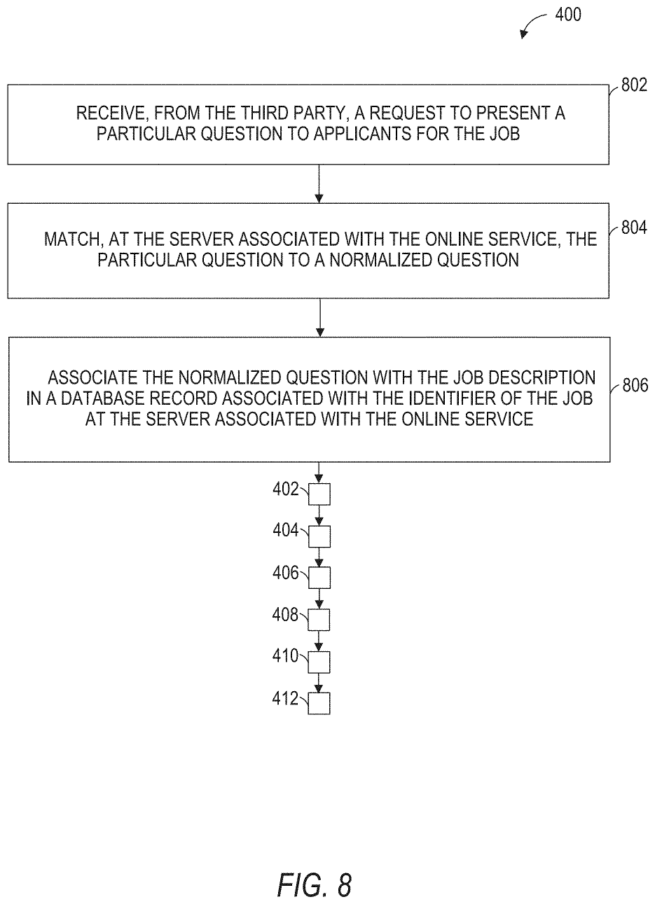

As shown in FIG. 8, the method 400 includes one or more of operations 802, 804, or 806, according to some example embodiments. Operation 802 may be performed before operation 402 of FIG. 4, in which the display module 302 causes display of the identifier of the job in the user interface of the client device associated with the user of the online service.

At operation 802, the communication module 304 receives, from the third party, a request to present a particular question to applicants for the job.

At operation 804, the analysis module 308 matches, at the server associated with the online service, the particular question to a normalized question stored in a database record that stores a taxonomy of questions.

At operation 806, the analysis module 308 associates the normalized question with the job description in a database record associated with the identifier of the job at the server associated with the online service. The one or more questions caused to display in the user interface of the client device include the normalized question.

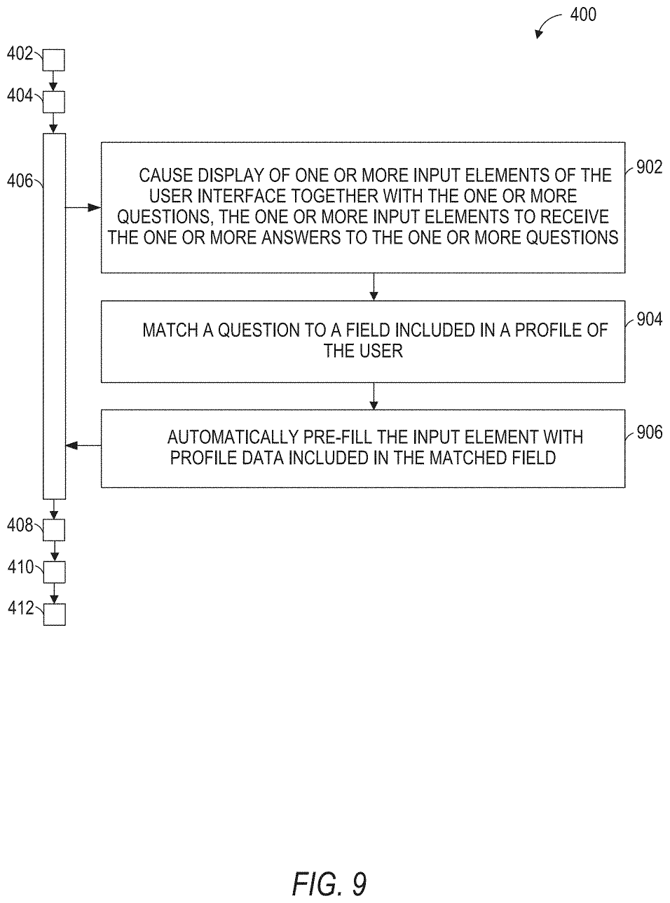

As shown in FIG. 9, the method 400 includes one or more of operations 902, 904, or 906, according to some example embodiments. Operation 902 may be performed as part (e.g., a precursor task, a subroutine, or a portion) of operation 406 of FIG. 6, in which the display module 302 causes display of the job description and one or more questions for the job in the user interface of the client device.

At operation 902, the display module 302 causes display of one or more input elements of the user interface together with the one or more questions, the one or more input elements to receive the one or more answers to the one or more questions. An input element of the one or more input elements corresponds to a question of the one or more questions.

At operation 904, the analysis module 308 matches the question to a field included in a profile of the user of the online service. The field may include profile data of a particular type (e.g., a first name, a last name, a street address, a city, an education institution, etc.).

At operation 906, the display module 302 automatically pre-fills the input element with profile data included in the matched field. The user may accept or correct the pre-filled data.

In some example embodiments, the one or more questions include a normalized question. The causing display of the job description and the one or more questions for the job in the user interface of the client device may include: causing display of one or more input elements of the user interface together with the one or more questions, the one or more input elements to receive the one or more answers to the one or more questions, an input element of the one or more input elements corresponding to the normalized question; matching the normalized question to a previously-provided answer stored in association with another application by the user of the online service in a database record; and automatically pre-filling the input element with the previously-provided answer.

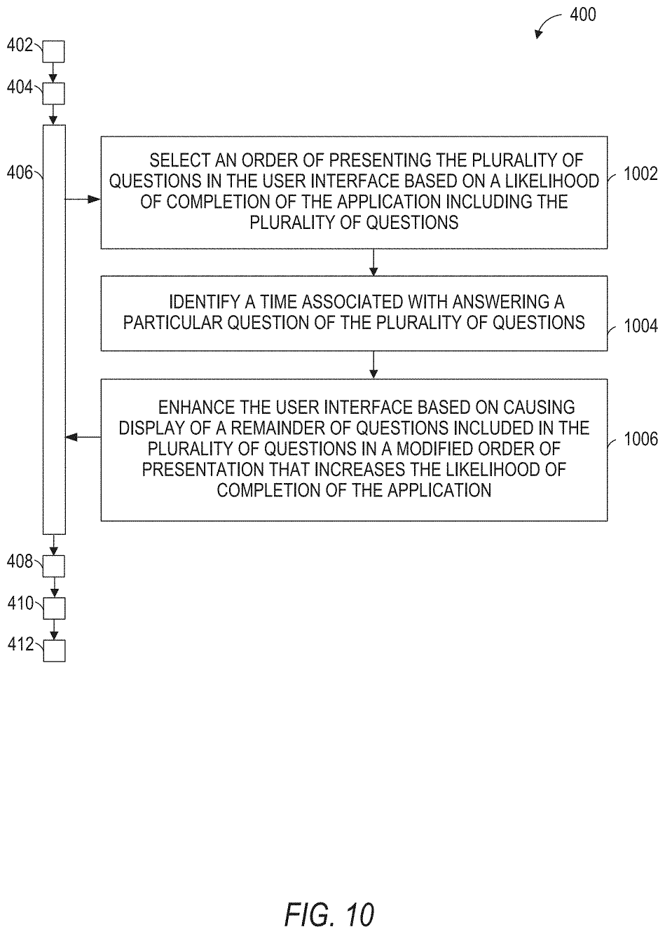

As shown in FIG. 10, the method 400 includes one or more of operations 1002, 1004, or 1006, according to some example embodiments. Operation 1002 may be performed as part (e.g., a precursor task, a subroutine, or a portion) of operation 406 of FIG. 6, in which the display module 302 causes display of the job description and one or more questions for the job in the user interface of the client device.

In some example embodiments, the one or more questions include a plurality of questions. At operation 1002, the analysis module 308 selects an order of presenting the plurality of questions in the user interface based on a likelihood of completion of the application including the plurality of questions.

The analysis module 308 identifies a time associated with answering a particular question of the plurality of questions.

The display module 304 enhances the user interface based on causing display of a remainder of questions included in the plurality of questions in a modified order of presentation that increases the likelihood of completion of the application. The enhancing of the user interface is performed in response to the identifying of the time associated with answering the particular question.

### Example Mobile Device

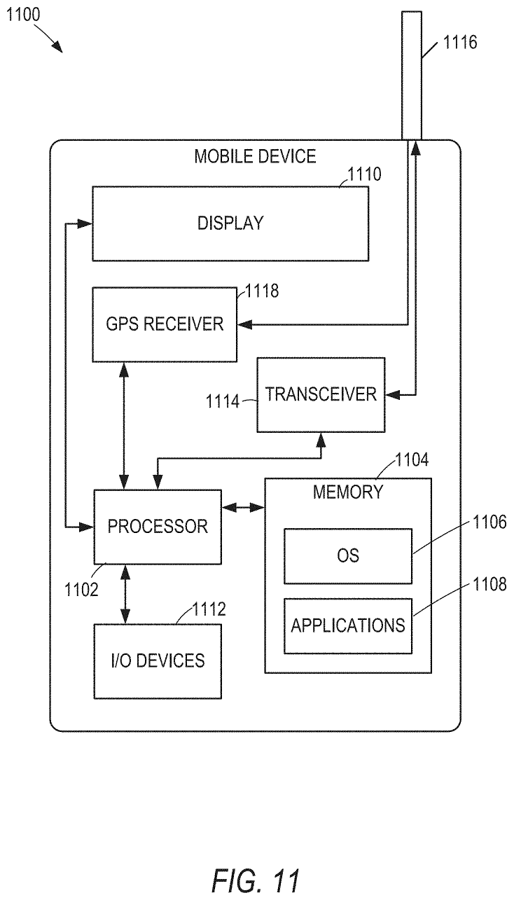

FIG. 11 is a block diagram illustrating the mobile device 1100, according to an example embodiment. The mobile device may correspond to, for example, one or more client machines or application servers. One or more of the modules of the system 300 illustrated in FIG. 3 may be implemented on or executed by the mobile device 1100. The mobile device 1100 may include a processor 1102. The processor 1102 may be any of a variety of different types of commercially available processors 1102 suitable for mobile devices 1100 (for example, an XScale architecture microprocessor, a microprocessor without interlocked pipeline stages (MIPS) architecture processor, or another type of processor 1102). A memory. 1104, such as a random access memory (RAM), a flash memory, or other type of memory, is typically accessible to the processor 1102. The memory 1104 may be adapted to store an operating system (OS) 1106, as well as application programs 1108, such as a mobile location enabled application that may provide LBSs to a user. The processor 1102 may be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 may be coupled to a transceiver 1114 that interfaces with an antenna 1116. The transceiver 1114 may be configured to both transmit and receive cellular network signals, wireless data signals, or other types of signals via the antenna 1116, depending on the nature of the mobile device 1100. Further, in some configurations, a GPS receiver 1118 may also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

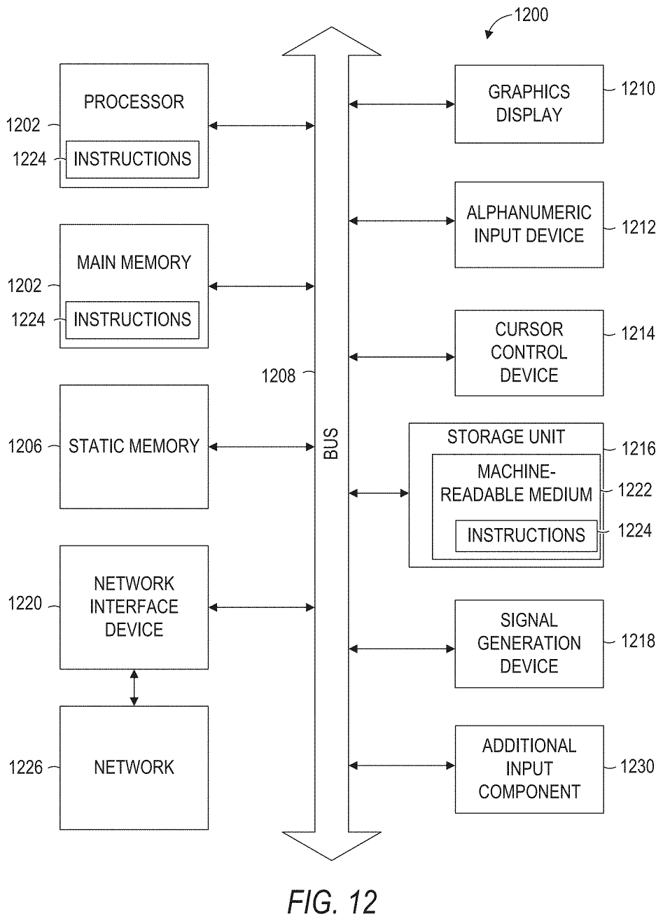

FIG. 12 is a block diagram illustrating components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 122.2 (e.g., a tangible and non-transitory machine-readable storage medium) on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media (e.g., tangible and non-transitory machine-readable media). The instructions 1224 may be transmitted or received over the network 1226 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer, and have one or more additional input components 1230 (e.g., sensors or gauges). Examples of such input components 1230 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers an altitude detection component (e.g., an altimeter and a gas detection component a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
causing display of an identifier of a job in a user interface of a client device associated with a user of an online service, the job being associated with a third party;
receiving, at a server associated with the online service, a request from the client device, the request being to view a job description for the job;
in response to the request to view the job description, causing display of the job description and one or more questions for the job in the user interface of the client device;
receiving, at the server associated with the online service, from the client device, one or more answers to the one or more questions and a request to apply for the job via the user interface;
in response to the request to apply for the job, generating, at the server associated with the online service, an application for the job, the application including the one or more answers to the one or more questions, the generating of the application being performed using one or more hardware processors; and
providing the third party with access to the application.

2. The method of claim 1, further comprising:
ingesting job data associated with the job from the server associated with the third party, the ingesting including accessing the job description and data pertaining to presentation of the job description to applicants for the job; and
accessing the one or more questions for the job from the server associated with the third party at a time of ingestion of the job from the server associated with the third party.

3. The method of claim 1, further comprising:
accessing the one or more questions for the job from the server associated with the online service.

4. The method of claim 1, further comprising:
accessing the one or more questions for the job;
transmitting a communication to a client device associated with the third party, the communication including one or more metrics pertaining to measuring one or more aspects of a job application process based on using the one or more questions.

5. The method of claim 4, further comprising:
in response to the communication, receiving approval to present the one or more questions to the user of the online service.

6. The method of claim 4, wherein the one or more metrics include a likelihood of completion, by one or more users of the online service including the user, of an application process based on presenting the one or more questions to the one or more users.

7. The method of claim 4, wherein the one or more metrics include a time of completion, by one or more users of the online service including the user, of an application process based on presenting the one or more questions to the one or more users.

8. The method of claim 1, further comprising:
accessing a plurality of questions for the job including the one or more questions;
transmitting a communication to a client device associated with the third party, the communication including one or more metrics pertaining to measuring one or more aspects of a job application process based on using the plurality of questions; and
in response to the communication, receiving a selection of the one or more questions to be presented to one or more applicants for the job, a use of the one or more questions in the job application process improving the one or more metrics.

9. The method of claim 1, further comprising:
generating, at the server associated with the online service, a database record that stores at least one of the identifier of the job, an identifier of the user, the one or more questions, the answers to the one or more questions, the application, or a time of the request, by the user, to apply for the job.

10. The method of claim 1, further comprising:
generating, at the server associated with the online service, a database record that stores at least one of the identifier of the job, the job description, or the one or more questions.

11. The method of claim 1, further comprising:
receiving, from the third party, a request to present a particular question to applicants for the job;
matching, at the server associated with the online service, the particular question to a normalized question stored in a database record that stores a taxonomy of questions; and
associating the normalized question with the job description in a database record associated with the identifier of the job at the server associated with the online service,
wherein the one or more questions caused to display in the user interface of the client device include the normalized question.

12. The method of claim 1, wherein the causing display of the job description and the one or more questions for the job in the user interface of the client device includes:
causing display of one or more input elements of the user interface together with the one or more questions, the one or more input elements to receive the one or more answers to the one or more questions, an input element of the one or more input elements corresponding to a question of the one or more questions;
matching the question to a field included in a profile of the user of the online service, the field including profile data of a particular type; and
automatically pre-filling the input element with profile data included in the matched field.

13. The method of claim 1, wherein the one or more questions include a normalized question, and wherein the causing display of the job description and the one or more questions for the job in the user interface of the client device includes:
causing display of one or more input elements of the user interface together with the one or more questions, the one or more input elements to receive the one or more answers to the one or more questions, an input element of the one or more input elements corresponding to the normalized question;
matching the normalized question to a previously-provided answer stored in association with another application by the user of the online service in a database record; and
automatically pre-filling the input element with the previously-provided answer.

14. The method of claim 1, further comprising:
determining that the job is eligible for application via the user interface,
wherein the causing display of the identifier of the job in the user interface of the client device is further based on the determining that the job is eligible for application via the user interface.

15. The method of claim 1, further comprising:
determining that the one or more questions are identified as available to be posted with the job,
wherein the causing display of the identifier of the job in the user interface of the client device is further based on the determining that the one or more questions are identified as available to be posted with the job.

16. The method of claim 1, further comprising:
providing a set of normalized questions to the third party; and
receiving an indication of a selection of the one or more questions from the set of normalized questions,
wherein the causing display of the identifier of the job in the user interface of the client device is further based on the receiving of the indication.

17. The method of claim 1, wherein the one or more questions include a plurality of questions, and wherein the causing display of the job description and the one or more questions for the job in the user interface of the client device includes:
selecting an order of presenting the plurality of questions in the user interface based on a likelihood of completion of the application including the plurality of questions;
identifying a time associated with answering a particular question of the plurality of questions; and
enhancing the user interface based on causing display of a remainder of questions included in the plurality of questions in a modified order of presentation that increases the likelihood of completion of the application, the enhancing of the user interface being in response to the identifying of the time associated with answering the particular question.

18. A system comprising:
one or more hardware processors; and
a non-transitory computer-readable medium storing instructions that, when executed by the one or more hardware processors, cause the one or more hardware processors to perform operations comprising:
causing display of an identifier of a job in a user interface of a client device associated with a user of an online service, the job being associated with a third party;
receiving, at a server associated with the online service, a request from the client device, the request being to view a job description for the job;
in response to the request to view the job description, causing display of the job description and one or more questions for the job in the user interface of the client device;
receiving, at the server associated with the online service, from the client device, one or more answers to the one or more questions and a request to apply for the job via the user interface;
in response to the request to apply for the job, generating, at the server associated with the online service, an application for the job, the application including the one or more answers to the one or more questions; and
providing the third party with access to the application.

19. The system of claim 18, wherein the operations further comprise:
ingesting job data associated with the job from the server associated with the third party, the ingesting including accessing the job description and data pertaining to presentation of the job description to applicants for the job; and
accessing the one or more questions for the job from the server associated with the third party at a time of ingestion of the job from the server associated with the third party.

20. A non-transitory computer-readable medium storing instructions that, when executed by the one or more hardware processors, cause the one or more hardware processors to perform operations comprising:
causing display of an identifier of a job in a user interface of a client device associated with a user of an online service, the job being associated with a third party;
receiving, at a server associated with the online service, a request from the client device, the request being to view a job description for the job;
in response to the request to view the job description, causing display of the job description and one or more questions for the job in the user interface of the client device;
receiving, at the server associated with the online service, from the client device, one or more answers to the one or more questions and a request to apply for the job via the user interface;
in response to the request to apply for the job, generating, at the server associated with the online service, an application for the job, the application including the one or more answers to the one or more questions; and
providing the third party with access to the application.
